(19) United States
(12) Patent Application Publication
(10) Pub. No.: US 2024/0140821 A1
(43) Pub. Date: May 2, 2024

(54) PREPARING METHOD FOR CATHODE ACTIVE MATERIAL PRECURSOR FOR LITHIUM-ION BATTERIES WITH TAILOR-MADE CONCENTRATION GRADIENT AND CO-PRECIPITATION REACTOR FOR TAILOR-MADE CONCENTRATION GRADIENT

(71) Applicant: PUSAN NATIONAL UNIVERSITY INDUSTRY-UNIVERSITY COOPERATION FOUNDATION, Busan (KR)

(72) Inventors: Hyun Deog YOO, Busan (KR); Seong Wook KIM, Busan (KR)

(73) Assignee: PUSAN NATIONAL UNIVERSITY INDUSTRY-UNIVERSITY COOPERATION FOUNDATION, Busan (KR)

(21) Appl. No.: 18/383,600

(22) Filed: Oct. 25, 2023

(30) Foreign Application Priority Data
Oct. 27, 2022 (KR) 10-2022-0140081
Apr. 6, 2023 (KR) 10-2023-0045114

(51) Int. Cl. C01G 53/00; H01M 10/0525

(52) U.S. Cl. CPC C01G 53/50; H01M 10/0525; C01P 2006/40

(57) ABSTRACT

A preparing method for a cathode active material precursor for a lithium-ion batteries with a tailor-made concentration gradient, includes: an aqueous metal ion solution preparation step for preparing an aqueous metal ion solution A for center and an aqueous metal ion solution B for surface having different compositions, concentrations, and volumes; a mixed metal ion solution formation step for gradually mixing the aqueous metal ion solution B for surface to the aqueous metal ion solution A for center; a control step for setting a composition and a concentration gradient of the mixed metal ion solution and controlling the same in real time, before moving the mixed metal ion solution to a co-precipitation reactor; and a co-precipitation reaction step for performing a co-precipitation reaction according to conditions set in the control step.

### CROSS-REFERENCE TO PRIOR APPLICATIONS

This Application claims priority to Korean Patent Application Nos. 10-2022-0140081 (filed on Oct. 27, 2022) and 10-2023-0045114 (filed on Apr. 6, 2023), which are all hereby incorporated by reference in their entirety.

### BACKGROUND

The present invention relates to a preparing method for a cathode active material precursor for lithium-ion batteries with a tailor-made concentration gradient; and a co-precipitation reactor with a tailor-made concentration gradient, specifically, a method and a device allowing for mass synthesis of cathode active material precursors with tailor-made design and control of a transition metal ratio and a concentration gradient.

The development of lithium secondary battery cathode materials with high energy density, efficiency, and stability is one of the most important factors in improving the performance and safety of electric vehicles and energy storage devices. Among them, high-nickel NCM (Li[NiₓCo_{y}Mn_{1-x-y}]O₂) is a three-element transition metal oxide of nickel, cobalt, and manganese, and is a lithium secondary battery cathode active material with a nickel content of more than 80%. Unlike other transition metals of which oxidation number changes from trivalent to tetravalent, such as cobalt and manganese, the oxidation number of nickel may change from divalent to tetravalent, and thus the nickel content is the most important factor in determining capacity. Therefore, as the nickel content increases, the number of lithium atoms inserted into/extracted from a lithium layer increases, compared to other transition metals such as cobalt and manganese, and the capacity thereby increases.

A high-nickel cathode active material comprises nickel divalent ions (0.69 Å) and lithium monovalent ions (0.76 Å) with similar ionic radii, which result in cation mixing that swaps nickel ions and lithium ions, which is a factor that brings about a decrease in usable capacity and rate capability. In addition, due to the presence of residual lithium salt on a surface after the sintering process, side reactions with an electrolyte may become severe to form a thick film, and a decrease of performance may occur. Activated tetravalent nickel ions generated during charging accelerate electrolyte decomposition on a particle surface to cause electrolyte depletion, and degrade the layered structure to spinel and rock-salt structures, forming a thick cathode solid-electrolyte interphase layer (CEI layer) and thereby causing rapid performance degradation. These side reactions are especially activated at high temperatures, and when a CEI is destroyed at high temperatures, an exothermic reaction is accelerated and oxygen in the cathode crystal structure is eventually released, leading to an ignition accident. As a result, since pure high-nickel cathode active materials are difficult to apply to actual batteries due to the rapid performance degradation because of the high reactivity of residual lithium salt and tetravalent nickel, a high-nickel cathode active material with a new structure is required.

To solve the problem described above, concentration gradient type cathodes have been developed in which an excessive amount of nickel is included in the central region and the nickel concentration decreases toward the surface. As highly reactive nickel was mainly present in the central region, the reactivity at a surface in contact with an electrolyte was reduced, and thus the thermal/electrochemical stability could be improved. However, as the process of designing and implementing a concentration gradient mainly relies on trial-and-error based on experiences, and thus has been performed by a relatively simple manner in which a solution for the particles' center with a high nickel proportion is mixed with a solution for the particles' surface with a low nickel proportion at a constant rate. Therefore, the process has many limitations in freely designing, optimizing, and experimentally implementing the concentration gradient and the total component ratio that satisfy the requirements of batteries. Therefore, the development of a method for freely designing and implementing the concentration gradient and the total component ratio of various metal ions may be considered as the most essential part in optimizing the performance of the concentration gradient type lithium-ion battery cathode materials.

Therefore, in order to compensate for the problems described above, the present inventors developed a methodology allowing for freely designing/implementing the concentration gradient and the total component ratio of metal ions. Through this, the present inventors co-precipitated and synthesized lithium-ion battery cathode precursors with tailor-made concentration gradients and completed an excellent cathode active material with optimized performance retention and electrochemical/thermal stability.

To design an average composition and a concentration gradient of transition metal ions in a cathode active material in a tailor-made way and freely control the same, the present invention provides a synthesis method for freely controlling a concentration gradient and an average composition and implementing the same by an automated system controlled with a computer through a process of expressing the flow rate of the feeding pump as a mathematical function having various forms with respect to time, establishing a differential equation with respect to the concentration of a metal ion that is put into a reactor in real time, and numerically solving the same to optimize parameters for designing and synthesizing various concentration gradient cathode material precursors in a tailor-made type. The present invention is implemented in a batch reactor that is used for mass synthesis of cathode materials in actual industrial sites and has high commercial feasibility and applicability.

### PRIOR ARTS

(Patent document 001) Korean Published Patent: 10-2019-0091155

### SUMMARY

The present invention has been derived to solve the problems described above, and an object of the present invention is to provide a cathode active material for lithium secondary batteries for which a tailor-made concentration gradient may be easily set up by freely designing and controlling an average composition and a ratio of transition metal ions; and a preparing method thereof.

In addition, another object of the present invention is to provide a cathode active material for lithium secondary batteries, the cathode active material being capable of effectively reducing the ratio of nickel ions on the surface by a tailor-made concentration gradient to minimize the decrease of rate characteristics due to a cation mixed layer, residual lithium salts formation, and electrolyte depletion; to form an optimal cathode solid-electrolyte interphase layer; and to minimize the mechanical stress due to a volumetric change during charging and discharging.

The technical problems to be solved by the invention are not limited to the technical problems mentioned above, and other technical problems that are not mentioned will be clearly understood by those skilled in the art from the description below.

(1) Preparing Method for a Cathode Active Material Precursor with a Tailor-Made Concentration Gradient for Lithium-Ion Batteries

The preparing method for a cathode active material precursor with a tailor-made concentration gradient for lithium-ion batteries according to the present invention includes:
step of preparing aqueous metal ion solutions having different compositions, concentrations, and volumes: an aqueous metal ion solution A for particles' center and another aqueous metal ion solution B for particles' surface;
a step to generate a mixed metal ion solution by gradually feeding and mixing the aqueous metal ion solution B for particles' surface into the aqueous metal ion solution A for particles' center;
a control step for setting an composition and a concentration gradient of the mixed metal ion solution and controlling the same in real time, before feeding the mixed metal ion solution to a co-precipitation reactor; and
a co-precipitation reaction step for performing a co-precipitation reaction according to conditions set in the control step.

Provided is a preparing method for a cathode active material precursor for lithium-ion batteries with a tailor-made concentration gradient, wherein in the step to generate a mixed metal ion solution,
a rate at which the aqueous metal ion solution B for surface is fed and mixed into a mixing tank is represented by [Mathematical Formula 1] below, which is a function of time (t):

u₂(t)=u₂(0)×exp(t/τ) [Mathematical Formula 1]

(Here, the initial mixing rate is u₂(0) and the time constant is τ.).

In the control step above,

concentration and compositional changes of the mixed metal ion solution put into the co-precipitation reactor are represented and controlled by a differential equation of [Mathematical Formula 5] below:

$$\frac{{dn}_{1} ( t )}{dt} + {n}_{1} ( t ) \cdot \frac{{u}_{1} ( t )}{{V}_{1} ( t )} - {C}_{2} {u}_{2} ( t ) = 0 \qquad [ Mathematical Formula 5 ]$$

(Here, the total volume of the mixed metal ion solution and the number of moles of a specific metal ion are V₁(t) and n₁(t), respectively; the input rate of the mixed metal ion solution into the co-precipitation reactor is u₁(t); and the concentration of the specific metal ion in the aqueous metal ion solution B for surface and the mixing rate into the mixing tank are C₂ and u₂(t), respectively.)

(2) Co-Precipitation Reactor for a Tailor-Made Concentration Gradient

The co-precipitation reactor for a tailor-made concentration gradient according to the present invention includes:
a first storage tank (mixing tank) storing an aqueous metal ion solution A for particles' center;
a second storage tank storing an aqueous metal ion solution B for particles' surface;
a co-precipitation reactor that receives a mixed metal ion solution from the mixing tank, into which the aqueous metal ion solution B for surface is continuously fed and mixed, together with an ammonia solution and a sodium hydroxide solution to perform a co-precipitation reaction; and
a controller part that sets and controls the composition and the concentration gradient of the mixed metal ion solution that is fed into the co-precipitation reactor.

(3) Preparing Method for a Cathode Active Material for Lithium-Ion Batteries with a Tailor-Made Concentration Gradient

The preparing method for a cathode active material for lithium-ion batteries with a tailor-made concentration gradient according to the present invention includes:
an aqueous metal ion solution preparation step for preparing an aqueous metal ion solution A for center and an aqueous metal ion solution B for surface having different compositions, concentrations, and volumes;
a mixed metal ion solution formation step for gradually mixing the aqueous metal ion solution B for surface to the aqueous metal ion solution A for center;
a control step for setting a composition and a concentration gradient of the mixed metal ion solution and controlling the same in real time, before feeding the mixed metal ion solution to a co-precipitation reactor;
a co-precipitation reaction step for performing a co-precipitation reaction according to conditions set in the control step; and
an active material preparation step for mixing a cathode active material precursor synthesized above and lithium hydroxide, and then heating and sintering the same to prepare a final active material.

By the solution to the problems described above, the present invention may allow for mass synthesis by co-precipitation which can freely design and control the average composition and the concentration gradient of a cathode material for lithium secondary batteries by using only sulfate salts of nickel, cobalt, and manganese, and may achieve coating and doping effects without adding other raw materials.

In addition, the tailor-made concentration gradient cathode active material prepared by the preparing method of the present invention has the highest concentration of nickel at the center and higher concentrations of cobalt and manganese toward the surface, and the average composition and the concentration gradient of metals can be freely designed and controlled to synthesize a tailor-made cathode active material.

In addition, the present invention may allow for synthesis of a cathode active material in which the average composition and the concentration gradient are precisely controlled according to the design, and the concentration gradient-tailor-made cathode active material synthesized through this method has improved surface stability, thus exhibiting excellent capacity and cycle life.

### BRIEF DESCRIPTION OF THE DRAWINGS

FIG. 1 is a diagram schematically showing a preparing method for a cathode active material precursor for lithium-ion batteries with a tailor-made concentration gradient, according to an embodiment of the present invention.

FIG. 2, A is a graph of a mixing rate u₂(t) of an aqueous metal ion solution for surface with respect to time, shown according to an embodiment of the present invention; and FIG. 2, B is a graph illustrating various concentration gradients of nickel metal ions in a cathode material precursor with respect to a dimensionless radius of cathode material particles.

FIG. 3 shows the results of electron beam microanalysis (EPMA; A-D), inductively coupled plasma optical emission spectroscopy (ICP-OES; E), and X-ray diffraction (XRD; F) shown to confirm a concentration gradient, average composition, and crystal structure of active materials prepared according to an embodiment of the present invention, respectively; wherein the cross-section of active materials (A) were used for the EPMA measurements for nickel (B), cobalt (C) and manganese (D).

FIG. 4 shows cycling and rate characteristics of a half-cell manufactured according to an embodiment of the present invention: A represents voltage profiles of cathode active materials; B shows specific capacity at different C-rates, that is, rate characteristics; C shows differential capacity plots of the voltage profiles by different number of cycling; and D shows the cycling performances at 1C rate.

FIG. 5 is a flow chart for performing concentration gradient design and material synthesis to prepare a cathode active material for lithium-ion batteries with a tailor-made concentration gradient according to an embodiment of the present invention.

FIG. 6 is a graph showing the average composition and concentration gradient designed through numerical analysis and optimization to create a positive electrode active material for lithium-ion batteries with a tailor-made concentration gradient according to an embodiment of the present invention.

FIG. 7 shows a graphical-user interface (GUI) that controls synthesis conditions in real time by interlocking hardware and software to prepare a cathode active material for lithium-ion batteries with a tailor-made concentration gradient according to an embodiment of the present invention.

### DETAILED DESCRIPTION

The terms used in this specification will be briefly explained, and the present invention will be described in detail.

The terms used in the present invention were selected as general terms that are currently widely used as much as possible while considering the function in the present invention, but they may vary depending on the intention of one of ordinary skill in the art, or a precedent or the emergence of new technology, etc. Therefore, the terms used in the present invention should be defined based on the meaning of the terms and the overall content of the present invention, rather than simply the name of the terms.

In the entire present specification, when a certain portion is described to “include” a certain component, unless otherwise stated, it means that other components may further be included, rather than excluding other components.

With reference to the attached drawings, embodiments of the present invention will be described below in detail so that those skilled in the art may easily implement the present invention. However, the present invention may be implemented in many different forms and is not limited to the embodiments described herein.

Specific details, including the problem to be solved by the present invention, the solutions to the problem, and the effect of the invention, are included in the embodiments and drawings described below. The advantages and features of the present invention and the methods for achieving the same will become clear by referring to the embodiments described in detail below along with the accompanying drawings.

Hereinafter, the present invention will be described in more detail with reference to the attached drawings.

(1) Cathode Active Material Precursor for Lithium-Ion Batteries with a Tailor-Made Concentration Gradient

The preparing method for a cathode active material precursor for lithium-ion batteries with a tailor-made concentration gradient according to the present invention is preferably performed by including the five steps described below, and the precursor is prepared by using a co-precipitation reactor with a tailor-made concentration gradient, which will be described below.

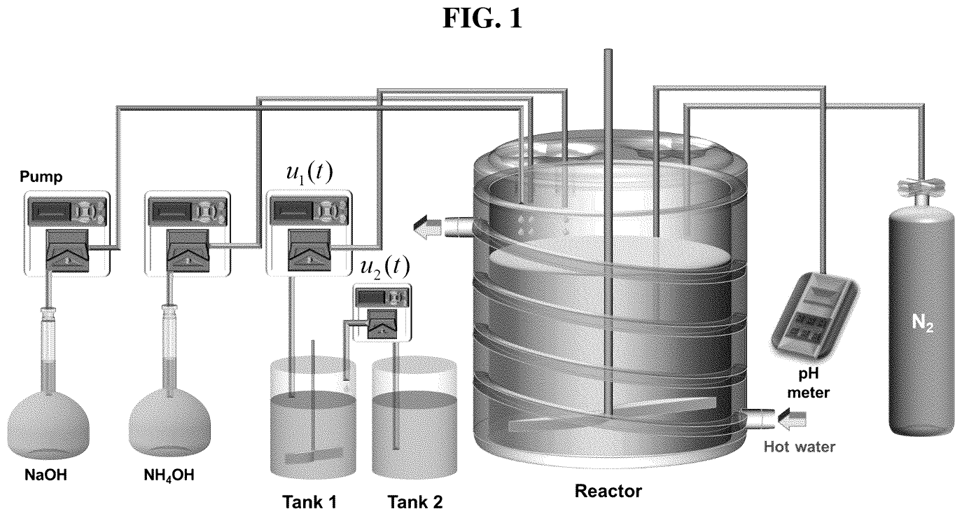

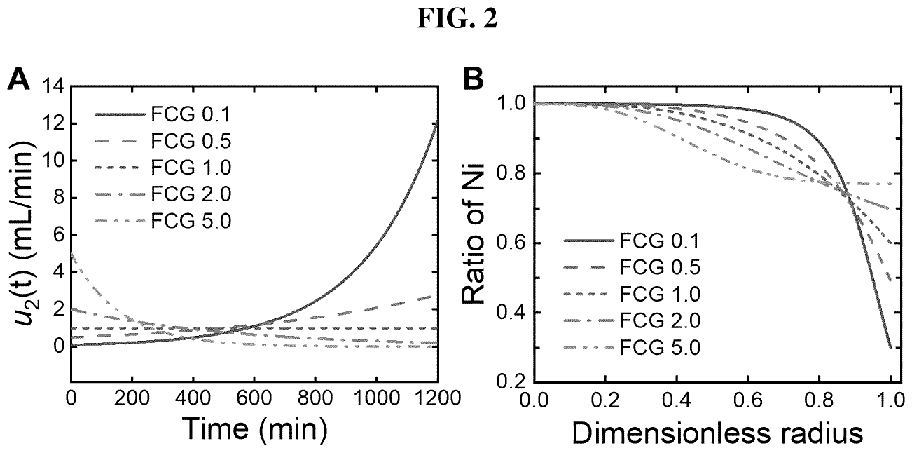

FIG. 1 is a diagram schematically showing the structure of a co-precipitation reactor to implement a tailor-made concentration gradient, which is the present invention. Metal ions react with sodium hydroxide to form a metal hydroxide precursor, while ammonia, as a complexing agent, controls the reaction rate by reducing the effective concentration of metal ions.

First, a first step (S10) is an aqueous metal ion solution preparation step. In the first step (S10), an aqueous metal ion solution A for center and an aqueous metal ion solution B for surface having different compositions, concentrations, and volumes are prepared.

The aqueous metal ion solution A for center is an aqueous nickel sulfate solution, and the aqueous metal ion solution B for surface is an aqueous solution in which cobalt sulfate and manganese sulfate of equal amounts are dissolved together. As the aqueous metal ion solution A for center, a 100% aqueous solution of nickel sulfate was prepared, and as the aqueous metal ion solution B for surface, a 50% aqueous solution of cobalt sulfate+50% aqueous solution of manganese sulfate was prepared.

Next, a second step (S20) is a mixed metal ion solution formation step. In the second step (S20), the aqueous metal ion solution B for surface is mixed into a mixing tank filled with the aqueous metal ion solution A for center. The rate at which the aqueous metal ion solution B for surface is mixed into the mixing tank is expressed as a mathematical function of time. Hereinafter, the number of moles and the concentration of nickel metal ions, which are the main component, were controlled, and the sum of the cobalt and manganese ion concentrations corresponds to the value obtained by subtracting the concentration of nickel ions from the total concentration of metal ions, 2.0 M.

In FIG. 1, Metal Solution 1 is a mixed metal ion solution in the mixing tank, and the volume (mL) of the mixed solution over time is defined as V₁(t), the molar concentration (M) of nickel ions therein is defined as C₁(t), and the number of moles (mol) of nickel ions therein is defined as n₁(t). Metal Solution 2 is the aqueous metal ion solution B for surface, and the molar concentration (M) of nickel ions therein is expressed as C₂, and the rate at which the aqueous metal ion solution for surface is mixed into the mixing tank is expressed as u₂(t), as in [Mathematical Formula 1]. The rate (mL/min) at which the resulting mixed metal ion solution is put into the co-precipitation reactor is defined as u₁(t).

u₂(t)=u₂(0)×exp(t/τ) [Mathematical Formula 1]

(Here, the initial mixing rate is u₂(0) and the time constant is τ.).

The volume of the mixed metal ion solution over time is given as a function of time with respect to u₁(t) and u₂(t) as shown in [Mathematical Formula 2] below. That is, in the mixed metal ion solution formation step, the volume of the mixed metal ion solution in the mixing tank is dependent on the input and output speed, and is expressed as [Mathematical Formula 2] below, which is a function of time.

V₁(t)=V₁(0)+∫₀^{T}[u₂(t)−u₁(t)]dt [Mathematical Formula 2]

(Here, the volume of the mixed metal ion solution is V₁(t); the rate at which the mixed metal ion solution is put into the co-precipitation reactor is u₁(t); and the rate at which the aqueous metal ion solution B for surface is mixed into the mixing tank is u₂(t)).

In addition, in the mixed metal ion solution formation step, the nickel molar concentration (M) of the mixed metal ion solution in the mixing tank over time is expressed as [Mathematical Formula 3] below.

$${C}_{1} ( t ) = \frac{{n}_{1} ( t )}{{V}_{1} ( t )} \qquad [ Mathematical Formula 3 ]$$

(Here, the molar concentration of nickel in the mixed metal ion solution is C₁(t); the number of moles of nickel in the mixed metal ion solution is n₁(t); and the volume of the mixed metal ion solution is V₁(t).)

The rate of change in the mole number n₁(t) of the aqueous metal ion solution in the mixing tank may be expressed by the differential equation of [Mathematical Formula 4].

$$\frac{{dn}_{1} ( t )}{dt} = - {C}_{1} ( t ) \cdot {u}_{1} ( t ) + {C}_{2} {u}_{2} ( t ) \qquad [ Mathematical Formula 4 ]$$

(Here, the number of moles of nickel in the mixed metal ion solution is n₁(t); the molar concentration of nickel is C₁(t); the rate at which the mixed metal ion solution is mixed into the co-precipitation reactor is u₁(t); the molar concentration of nickel in the aqueous metal ion solution B for surface is C₂; and the rate at which the aqueous metal ion solution B for surface is mixed into the mixing tank is u₂(t).)

Next, a third step (S30) is a control step. In the third step (S30), the composition of the mixed metal ion solution of the mixing tank put into the co-precipitation reactor is controlled in real time according to pre-designed average composition and concentration gradient.

The rate at which the aqueous metal ion solution for surface is mixed into the mixing tank was expressed as a mathematical function over time, and was designed and controlled as a key variable, together with the initial volume of the mixed metal ion solution in the mixing tank, to control average composition and concentration gradient. In the present invention, the average composition of nickel:cobalt:manganese of the active material can be freely designed and controlled, but in the embodiments, the average composition of all active materials was designed to be fixed at 80:10:10 in order to compare the effects of concentration gradient only.

The Mathematical Formulas 3 and 4 are combined to obtain [Mathematical Formula 5] as a differential equation for n₁(t). In the control step, changes of the concentration and composition of the mixed metal ion solution put into the co-precipitation reactor are expressed as the differential equation shown in [Mathematical Formula 5] below to control them. That is, n₁(t) is derived and controlled as a numerical solution of [Mathematical Formula 5], and then C₁(t) is derived and controlled from Mathematical Formulas 2 and 3. Through the numerical analysis of the differential equation and optimization algorithm, u₂(t), which implements target values of the average composition and the concentration gradient, may be obtained. At this time, u₂(t) is a general mathematical function and may be expressed, for example, in the form of an exponential function as in Mathematical Formula 1. The u₂(t) in the form of an exponential function has the initial input rate u₂(0) and the time constant τ as parameters, and therefore, as shown in Table 1, when these two parameters, u₂(0) and τ, are determined through numerical analysis and optimization algorithm, these two parameters may be implanted in a quantitative pump control system to synthesize a concentration gradient-tailor-made cathode material precursor with desired average composition and concentration gradient.

$$\frac{{dn}_{1} ( t )}{dt} + {n}_{1} ( t ) \cdot \frac{{u}_{1} ( t )}{{V}_{1} ( t )} - {C}_{2} {u}_{2} ( t ) = 0 \qquad [ Mathematical Formula 5 ]$$

(Here, the number of moles of nickel in the mixed metal ion solution is n₁(t); the volume of mixed metal ion solution is V₁(t); the rate at which the mixed metal ion solution is put into the co-precipitation reactor is u₁(t); the rate at which the aqueous metal ion solution B for surface is mixed into the mixing tank is u₂(t); and the molar concentration of nickel in the aqueous metal ion solution B for surface is C₂.)

Next, a fourth step (S40) is a co-precipitation reaction step. In the fourth step (S40), a co-precipitation reaction is performed according to conditions set in the control step.

In the co-precipitation reaction step, an ammonia solution and a sodium hydroxide solution are put into the co-precipitation reactor together with the mixed metal ion solution to perform a co-precipitation reaction. An ammonia solution is added to the co-precipitation reactor, and oxygen is removed through purging nitrogen gas. During this process, the temperature of the co-precipitation reactor is maintained at 40 to 60° C., and the stirring speed is maintained at 400 to 2,000 rpm.

Here, the ammonia solution and the sodium hydroxide solution are added such that the ammonia concentration and the pH in the reactor are maintained at pre-designed constant values in ranges of 0.5 to 1.2 M and 10.0 to 11.5, respectively.

The mixed metal ion solution is added to the co-precipitation reactor under condition that a sum of all metal ion concentrations is maintained constantly.

The ammonia solution and the sodium hydroxide solution were put into the co-precipitation reactor at 1 mL/min, and the aqueous metal ion solutions mixed above were added at a constant rate, more specifically, at 2 mL/min. All solutions were added for a total of 20 hours, and then the yield of the precipitate was increased by additional duration of 30 minutes after completion of adding metal ions solution. After filtering the precipitate, it was washed with distilled water and dried in a vacuum oven at 80° C. for 12 hours to obtain an active material precursor.

(2) Co-Precipitation Reactor of Cathode Active Material Precursor for Lithium-Ion Batteries with a Tailor-Made Concentration Gradient

The co-precipitation reactor system to implement a tailor-made concentration gradient according to the present invention is performed by the preparing method for a cathode active material precursor for lithium-ion batteries with a tailor-made concentration gradient described above.

FIG. 1 is a diagram schematically showing the structure of a co-precipitation reactor to implement a tailor-made concentration gradient, which is the present invention. Metal ions react with sodium hydroxide to form a metal hydroxide precursor, while ammonia, as a complexing agent, controls the reaction rate by reducing the effective concentration of metal ions.

The co-precipitation reactor that implements a tailor-made concentration gradient includes a first storage tank; a second storage tank; a co-precipitation reactor; and a control system.

The first storage tank (mixing tank) is initially filled with the aqueous metal ion solution A for center, and as mixing progresses, the mixed metal ion solution is stored.

The aqueous metal ion solution B for surface is stored in the second storage tank.

The aqueous metal ion solution A for center is an aqueous solution of nickel sulfate, and the aqueous metal ion solution B for surface is aqueous solutions of cobalt sulfate and manganese sulfate of the equal amount. Specifically, the aqueous metal ion solution A for center is a 100% aqueous solution of nickel sulfate, and the aqueous metal ion solution B for surface is a 50% aqueous solution of cobalt sulfate+50% manganese sulfate.

The co-precipitation reactor performs a co-precipitation reaction by adding an ammonia solution and a sodium hydroxide solution together with a mixed metal ion solution prepared by gradually mixing the aqueous metal ion solution B for surface into the mixing tank.

The co-precipitation reaction is performed by putting an ammonia solution and a sodium hydroxide solution into the co-precipitation reactor together with the mixed metal ion solution. An ammonia solution is added to the co-precipitation reactor, and oxygen is removed through purging nitrogen gas. During this process, the temperature of the co-precipitation reactor is maintained at 40 to 60° C., and the stirring speed is maintained at 400 to 2,000 rpm.

Here, the ammonia solution and the sodium hydroxide solution are added such that the ammonia concentration and the pH in the reactor are maintained at pre-designed constant values in ranges of 0.5 to 1.2 M and 10.0 to 11.5, respectively.

The ammonia solution and the sodium hydroxide solution were put into the co-precipitation reactor at 1 mL/min, and the mixed metal ion solution mixed above was added at a constant rate, more specifically, at 2 mL/min. All solutions were added for a total of 20 hours, and then the yield of the precipitate was increased for a duration of 30 minutes after the completion of adding the metal ion solution. After filtering the precipitate, it was washed with distilled water and dried in a vacuum oven at 80° C. for 12 hours to obtain an active material precursor.

The control system sets and controls the composition and the concentration gradient of a mixed solution moving to the co-precipitation reactor.

The control system includes a flow rate control unit controlling the rate at which the aqueous metal ion solution B for surface is mixed into the mixing tank, and the mixing rate is obtained as a solution of Mathematical Formulas 1 to 5 as a function of time.

As described above, the rate at which the aqueous metal ion solution for surface is mixed into the mixing tank was expressed as a mathematical function over time, as in [Mathematical Formula 1], and the initial mixing rate u₂(0) and the time constant τ were designed and controlled as key variables, together with the initial volume of the aqueous metal ion solution for center, to control average composition and concentration gradient. At this time, the average composition of nickel:cobalt:manganese can be freely designed and controlled, but in this specific embodiment, the average composition of all active materials was fixed at 80:10:10 in order to fairly compare only the effect of concentration gradient.

The volume of the aqueous metal ion solution in the mixing tank is given as a function of time with respect to u₁(t) and u₂(t) as shown in [Mathematical Formula 2]. That is, the control unit controls the volume of the mixed solution V₁(t) according to [Mathematical Formula 2] below, which is a function of time that is dependent upon the rate at which the mixed metal ion solution is put into the reactor and the rate at which the aqueous metal ion solution B is mixed into the mixing tank.

V₁(t)=V₁(0)+∫₀^{T}[u₂(t)−u₁(t)]dt [Mathematical Formula 2]

(Here, the volume of the mixed metal ion solution is V₁(t); the rate at which the mixed metal ion solution is put into the co-precipitation reactor is u₁(t); and the rate at which the aqueous metal ion solution B for surface is mixed into the mixing tank is u₂(t).)

In addition, the control system includes a concentration control unit controlling the molar concentration (M) of a metal ion of the mixed metal ion solution, and in the concentration control unit, the molar concentration (M) of nickel of the mixed metal ion solution over time is expressed as a solution of Mathematical Formulas 1 to 5.

The molar concentration (M) of nickel of the mixed metal ion solution over time is expressed as [Mathematical Formula 3] below.

$${C}_{1} ( t ) = \frac{{n}_{1} ( t )}{{V}_{1} ( t )} \qquad [ Mathematical Formula 3 ]$$

(Here, the molar concentration of nickel in the mixed metal ion solution is C₁(t); the number of moles of nickel in the mixed metal ion solution is n₁(t); and the volume of the mixed metal ion solution is V₁(t).)

In addition, the control system includes a mixed solution control unit changing the concentration and the composition of the mixed metal ion solution put into the co-precipitation reactor, and the mixed solution control unit controls the composition of a mixed solution in real time by controlling the mixing rate u₂(t), which is the mixing rate of the aqueous metal ion solution B for surface derived from the process of optimizing the concentration gradient and the average composition of particles from the numerical solution of the differential equation of [Mathematical Formula 5] below, as a function of time, with a computer-hardware interlocking system.

$$\frac{{dn}_{1} ( t )}{dt} + {n}_{1} ( t ) \cdot \frac{{u}_{1} ( t )}{{V}_{1} ( t )} - {C}_{2} {u}_{2} ( t ) = 0 \qquad [ Mathematical Formula 5 ]$$

(Here, the total volume of the mixed metal ion solution and the number of moles of a metal are V₁(t) and n₁(t), respectively; the rate at which the mixed metal ion solution is put into the co-precipitation reactor is u₁(t); the concentration of the metal ion in the aqueous metal ion solution B for surface is C₂; and the rate at which B is mixed into the mixing tank is u₂(t).)

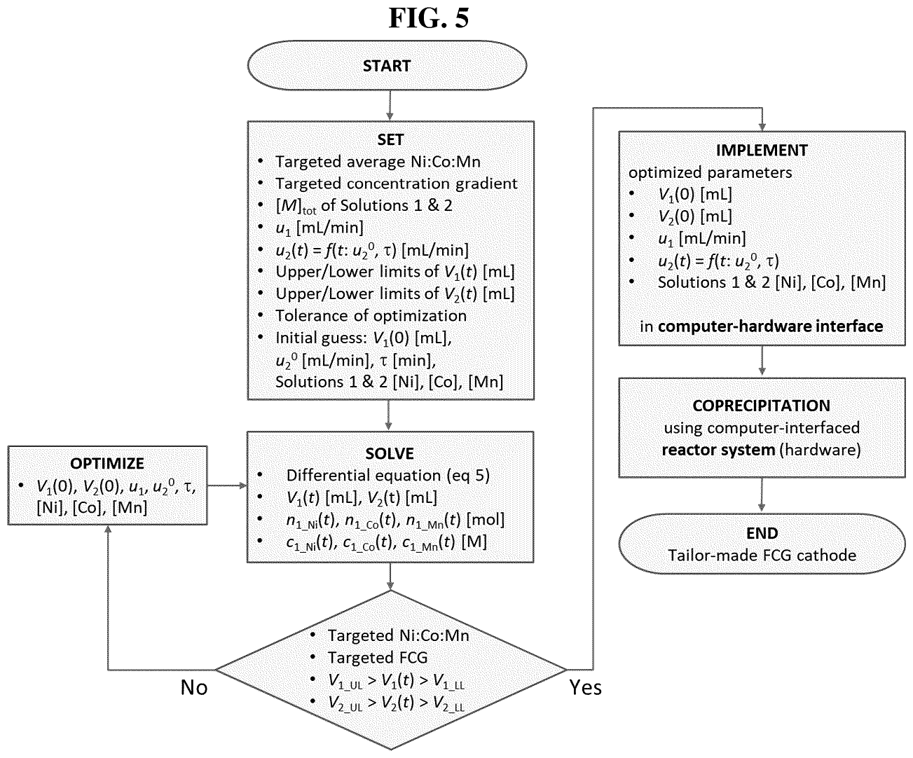

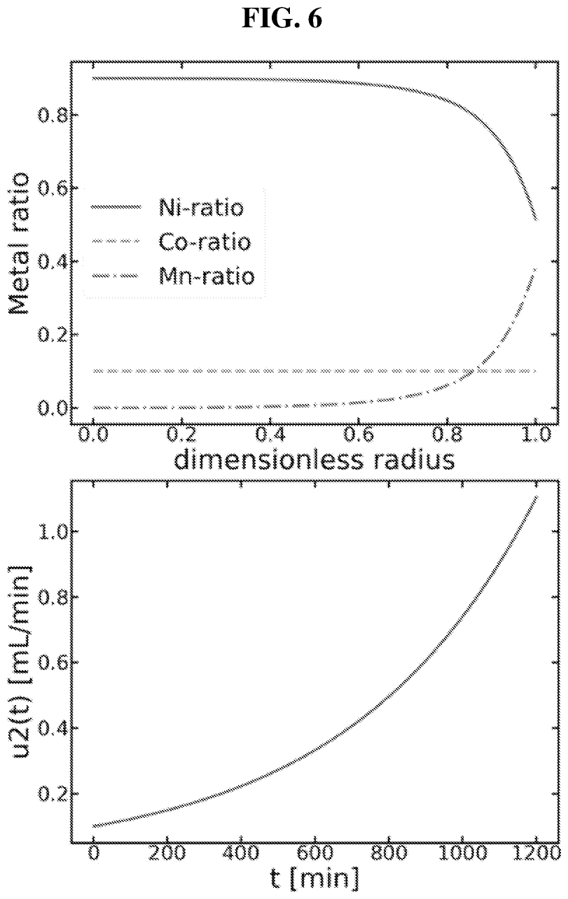

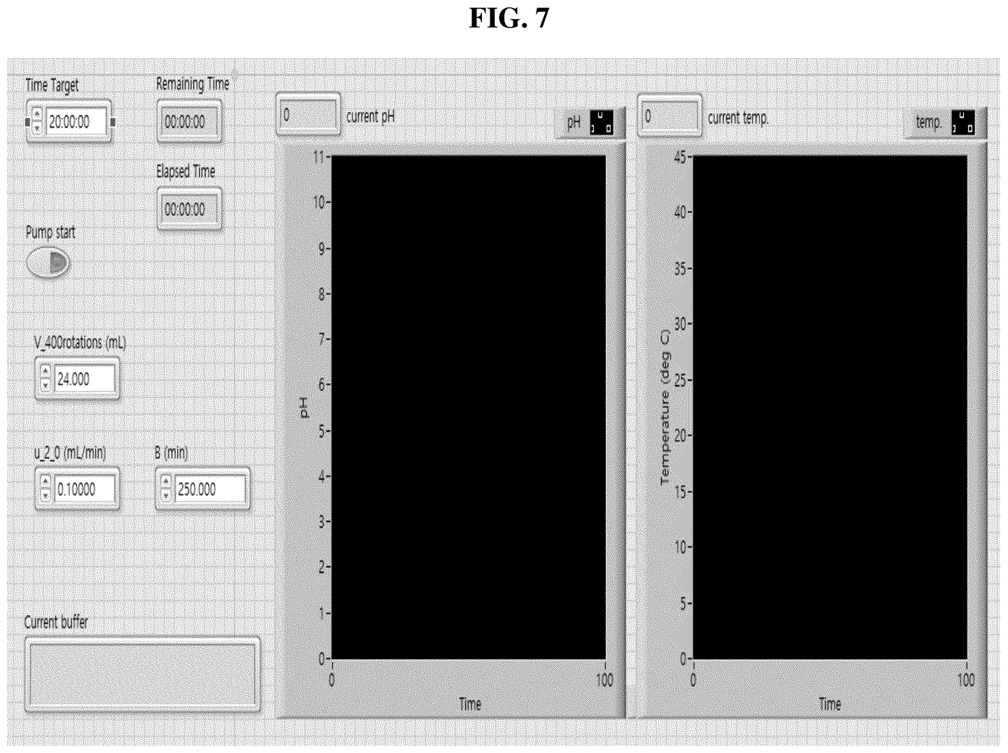

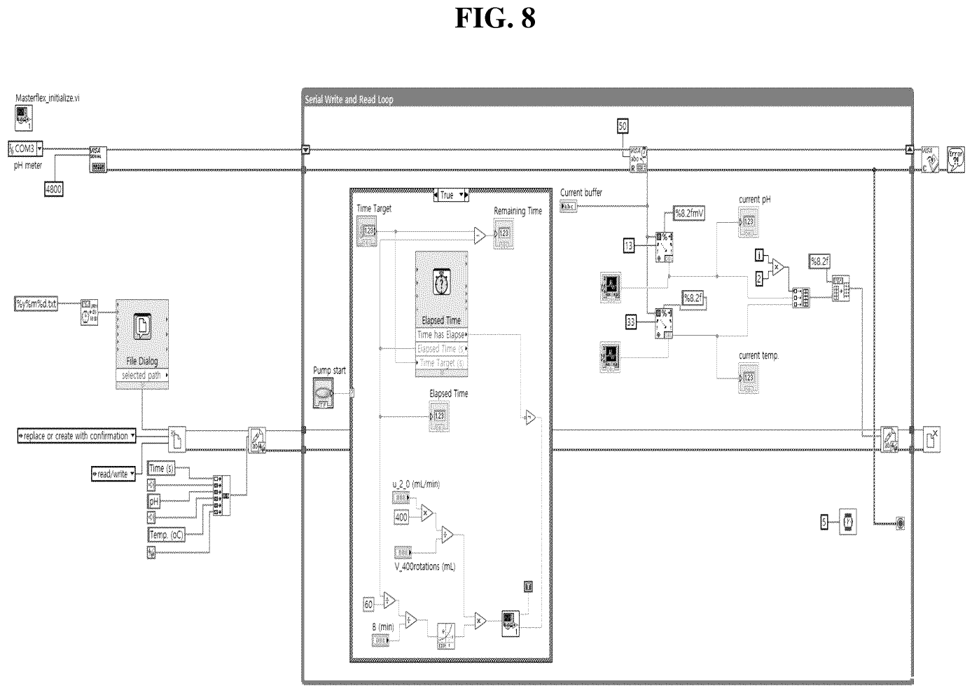

More specifically, as shown in FIG. 5, the control system may be manufactured as a co-precipitation reaction design algorithm for concentration gradient formation and a computer-hardware interlocking system that implements the same into synthesis.

A setting step is a design variable setting step for preparing precursors with a tailor-made concentration gradient, and it is herein described, merely as an example to aid understanding, based on preparation method of a three-component NCM concentration gradient cathode material based on nickel, cobalt, and manganese, but the present invention may be applied to cathode materials of general lithium-ion batteries with the same principles and methods.

First, as a step of setting an average composition of Ni:Co:Mn, there is generally the advantage that, as the ratio of nickel increases, the capacity of cathode materials increases, and thus the energy density increases, but at the same time, there is the disadvantage that the reactivity on the surface also increases, causing problems in lifespan and safety. Therefore, an average composition satisfying the requirements is set in consideration of these two factors.

Next, a concentration gradient of a precursor is set. A concentration gradient may be quantitatively expressed as the rate of change of the nickel ratio in the radial direction from the center to the surface.

Next, the total metal ion concentration ([M]ₜₒₜ) and the Ni:Co:Mn composition of each aqueous metal ion solution in the first storage tank and the second storage tank are determined.

Beside the co-precipitation reactor are the first storage tank and the second storage tank filled with aqueous metal ion solutions containing high-ratio and low-ratio nickel, respectively. During the reaction, as the aqueous metal ion solution is mixed from the second storage tank into the first storage tank (mixing tank), the nickel ratio of the aqueous metal ion solution in the mixing tank gradually decreases in real time, and in the co-precipitation reactor, the aqueous metal ion solution supplied from this mixing tank undergoes co-precipitation, and a spherical precursor grows. Since the nickel ratio in the aqueous metal ion solution supplied during the growth of the precursor gradually decreases, a concentration gradient precursor in which the nickel ratio decreases from the center of the precursor to the surface is generated.

Here, the nickel molar concentration (M) of the aqueous metal ion solution in the first storage tank (mixing tank) over time is defined as C₁(t); the volume (mL) is defined as V₁(t), and the number of moles (mol) is defined as n₁(t). The molar concentration (M) of nickel in the second storage tank solution, that is, the aqueous metal ion solution for concentration control, is expressed as a constant C₂, and the rate at which the aqueous metal ion solution in the second storage tank is mixed into the first storage tank is expressed as u₂(t). At this time, u₂(t) is a function of time and has the initial mixing rate u₂(0) and the time constant τ as parameters. The rate (mL/min) at which the mixed metal ion solution with a real time-controlled nickel ratio flows from the first storage tank to the reactor is defined as the constant u₁.

Next, an upper limit and a lower limit of the volume of each of the first storage tank solution and second storage tank solution, V₁(t) and V₂(t), are determined according to the size.

Next, tolerances and initial values for executing the optimization algorithm are set.

In a solution step, the time-averaged value of the nickel concentration C₁(t) of the aqueous metal ion solution in the first storage tank, obtained by numerical analysis of [Mathematical Formula 5], corresponds to the average nickel fraction of the final precursor. The average fractions of cobalt and manganese may also be determined in the same manner.

An optimization step determines the parameters by which the desired average composition and concentration gradient are realized, by using an optimization algorithm. The finally obtained parameters are the initial volumes, V₁(0) and V₂(0), of the aqueous metal ion solutions in the first and the second storage tanks, the respective Ni:Co:Mn compositions, the initial mixing rate u₂(0) and the time constant τ of of u₂(t), and u₁.

A co-precipitation step implements an actual co-precipitation reaction with optimized parameters. This is a step for performing an actual co-precipitation reaction by implementing the optimized parameters into a reactor system that interlocks hardware such as pumps and pH meters to a computer through programming that allows for computer-hardware interfaces such as LabVIEW™. At this time, the key part is to control, as a mathematical function of time, the rate u₂(t) at which the aqueous metal ion solution is mixed from the second storage tank to the first storage tank. As a result, a tailor-made concentration gradient cathode material precursor with precisely controlled concentration gradient and average composition is actually synthesized.

(3) Preparing Method for a Cathode Active Material for Lithium-Ion Batteries with a Tailor-Made Concentration Gradient

The preparing method for a cathode active material for lithium-ion batteries with a tailor-made concentration gradient according to the present invention is performed by adding an active material preparation step to the preparing method for a cathode active material precursor for lithium-ion batteries with a tailor-made concentration gradient described above.

First, a first step (S10) is an aqueous metal ion solution preparation step. In the first step (S10), an aqueous metal ion solution A for center and an aqueous metal ion solution B for surface having different compositions, concentrations, and volumes are prepared.

Next, a second step (S20) is a mixed metal ion solution formation step. In the second step (S20), the aqueous metal ion solution B for surface is mixed into the mixing tank. The rate at which the aqueous metal ion solution B for surface is mixed into the mixing tank is expressed as a mathematical function over time.

Next, a third step (S30) is a control step. In the third step (S30), the composition and the concentration gradient of the mixed metal ion solution are set and controlled in real time before moving the mixed solution to a co-precipitation reactor.

Next, a fourth step (S40) is a co-precipitation reaction step. In the fourth step (S40), a co-precipitation reaction is performed according to conditions set in the control step.

Next, a fifth step (S50) is an active material preparation step. The cathode active material precursor synthesized in the fourth step (S40) and lithium hydroxide are mixed, and then heated and sintered to prepare a final active material.

After mixing the active material precursor and lithium hydroxide, the resulting mixture is heated at a temperature increase rate of 5° C./min, maintained at 500° C. for 5 hours, and then sintered at 750 to 800° C. for 10 hours to obtain a final active material.

Hereinafter, comparative examples, prepared by conventional methods, and examples will be compared, and the present invention will be described in more detail through experimental examples. The purpose, features, and advantages of the present invention will be easily understood through the examples described below. The present invention is not limited to the examples described herein and may be specified in other forms. The examples introduced herein are provided to enable the idea of the present invention to be sufficiently conveyed to those skilled in the art to which the present invention pertains. Therefore, the present invention should not be limited by the examples described below.

### Example 1. Preparation of a Concentration Gradient High-Nickel Cathode Active Material

As the aqueous metal ion solution A for center, a 100% aqueous solution of nickel sulfate was prepared, and as the aqueous metal ion solution B for surface, a 50% aqueous solution of cobalt sulfate+50% aqueous solution of manganese sulfate was prepared. The rate at which the aqueous metal ion solution for surface is mixed into the mixing tank was expressed as a mathematical function over time, and the initial mixing rate and the time constant were designed and controlled as key variables as shown in Table 1, together with the initial volume of the aqueous metal ion solution for center, to control average composition and concentration gradient.

At this time, the overall average composition of nickel:cobalt:manganese of all active materials was fixed at 80:10:10. In addition, for co-precipitation, an ammonia solution and a sodium hydroxide solution were prepared.

The ammonia solution was added to a co-precipitation reactor, and oxygen was removed through nitrogen gas. During this process, the temperature of the co-precipitation reactor was maintained at 40 to 60° C., and the stirring speed was maintained at 400 to 2,000 rpm. The ammonia solution and the sodium hydroxide solution were put into the reactor at 1 mL/min, and the aqueous metal ion solutions mixed above were added at 2 mL/min. All solutions were added for a total of 20 hours, and then the yield of the precipitate was increased for a duration of 30 minutes after the completion of adding the mixed metal ion solution. After filtering the precipitate, it was washed with distilled water and dried in a vacuum oven at 80° C. for 12 hours to obtain an active material precursor.

After mixing the active material precursor and lithium hydroxide, the resulting mixture was heated at a temperature increase rate of 5° C./min, maintained at 500° C. for 5 hours, and then sintered at 780° C. for 10 hours to obtain a final active material.

### Examples 2 to 5. Preparation of Concentration Gradient High-Nickel Cathode Active Materials

Except that the rate at which the aqueous metal ion solution for surface is mixed into the mixing tank was adjusted as shown in Table 1 according to [Mathematical Formula 1], active material particles were obtained in the same manner as Example 1 above.

TABLE 1
Rate at which the aqueous metal ion solution for
surface is mixed into the mixing tank (u₂(t))

| u₂(t) = u₂(0) · exp(t/τ) | u₂(0) | τ |
|---|---|---|
| Example 1 | 0.1 | 250 |
| Example 2 | 0.5 | 700 |
| Example 3 | 1.0 | ∞ |
| Example 4 | 2.0 | −530 |
| Example 5 | 5.0 | −161 |

### Comparative Example 1. Preparation of Mere High-Nickel Cathode Active Material without a Concentration Gradient

Except that an aqueous nickel:cobalt:manganese metal ion solution with a constant molar ratio of 80:10:10 was put into the reactor as a single aqueous metal ion solution, a cathode active material was synthesized under the same conditions.

### Example 6. Manufacturing of Coin-Type Half-Cells

According to Examples 1 to 5 and Comparative Example 1, a three-component lithium transition metal oxide, in which the average composition of nickel:cobalt:manganese was fixed at 80:10:10 and the concentration gradient was freely designed and controlled, as a cathode active material, carbon black (Super-P, Timcal Co.), as a conductive agent, and polyvinylidene fluoride (PVdF, KF1100, Kureha Co.), as a binder, were mixed at a weight ratio of 80:10:10, and the resulting mixture was mixed together with a solvent, N-methyl-2-pyrrolidinone (NMP, Sigma-Aldrich, 99.5%), to prepare a cathode slurry. The prepared slurry was applied to one side of an aluminum current collector in a thickness of 50 m, dried in a vacuum oven at 80° C. for 2 hours, and then pressed by using a roll press. The resulting electrode was punched into a circular shape with a diameter of 11 mm, dried in a vacuum oven at 80° C. for 10 hours, and then used.

The electrochemical properties were analyzed by manufacturing half cells by using a 2032-type coin cell. As an electrolyte, a solution prepared by dissolving 1 M lithium hexafluorophosphate (LiPF₆) in a mixed solvent of ethylene carbonate (EC) and ethyl methyl carbonate (EMC) (EC:EMC=3:7 w/w; SL19-0192; PanaXetec Co.) was used, and as a separator, a porous polyethylene (PE; Celgard Co.) film was used. All cells were assembled in a glove box filled with argon gas.

### Experimental Example 1. Confirmation of Average Composition of Cathode Active Materials

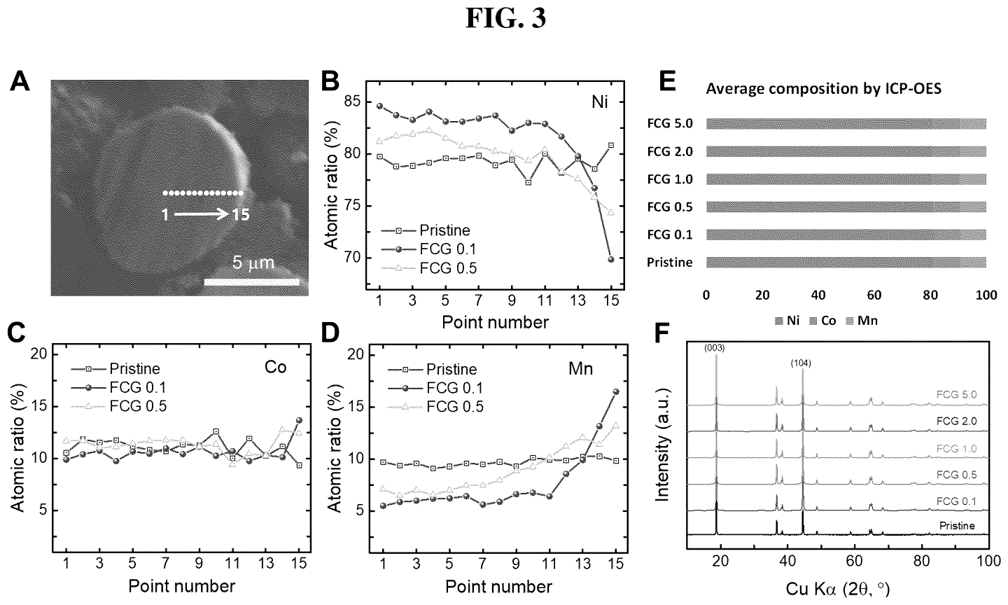

To confirm the average composition of the cathode active material prepared by the synthesis method of the present invention, Examples 1 to 5 and Comparative Example 1 were measured by using an inductively coupled plasma optical emission spectrometer (ICP-OES), and the results are shown in Table 2 and FIG. 3, E. In all cases, the average composition of nickel:cobalt:manganese had a molar ratio of 80:10:10, which was a result that exactly matched the mathematically designed value, proving the usefulness and accuracy of the methodology according to the present invention.

TABLE 2
Percentage of Ni, Co, and Mn in cathode active
materials based on ICP-OES analysis

| | Ni | Co | Mn |
|---|---|---|---|
| Example 1 | 81.70 | 9.11 | 9.19 |
| Example 2 | 80.67 | 9.54 | 9.78 |
| Example 3 | 80.47 | 9.85 | 9.68 |
| Example 4 | 79.95 | 10.29 | 9.77 |
| Example 5 | 81.09 | 9.60 | 9.35 |
| Comparative | 81.53 | 9.53 | 9.25 |
| Example 1 | | | |

### Experimental Example 2. Confirmation of the Concentration Gradient of Cathode Active Materials

To confirm whether there is a concentration gradient from the center to the surface in the active material particles prepared by the present invention, the quantitative element ratio from the center to the surface was measured by using electron probe micro-analysis (EPMA), and the results are shown in FIG. 3.

FIG. 3, A-D is the EPMA results shown to confirm the concentration gradient of metal ions from the center to the surface of the active materials prepared in Examples 1 and 2 and Comparative Example 1 of the present invention. FIG. 3, F shows that all the synthesized samples exhibit the characteristic R-3m crystal structure as a layered cathode material.

As shown in FIG. 3, B, the element ratio of nickel is constant from the center to the surface in the case of Comparative Example 1, but it can be confirmed that the elemental ratio of nickel decreased from the center to the surface in the active materials prepared in Examples 1 and 2. In addition, it can be confirmed that, as designed, the concentration gradient of Example 1 was significantly larger than that of Example 2.

### Experimental Example 3. Evaluation of Characteristics of Electrochemical Cells

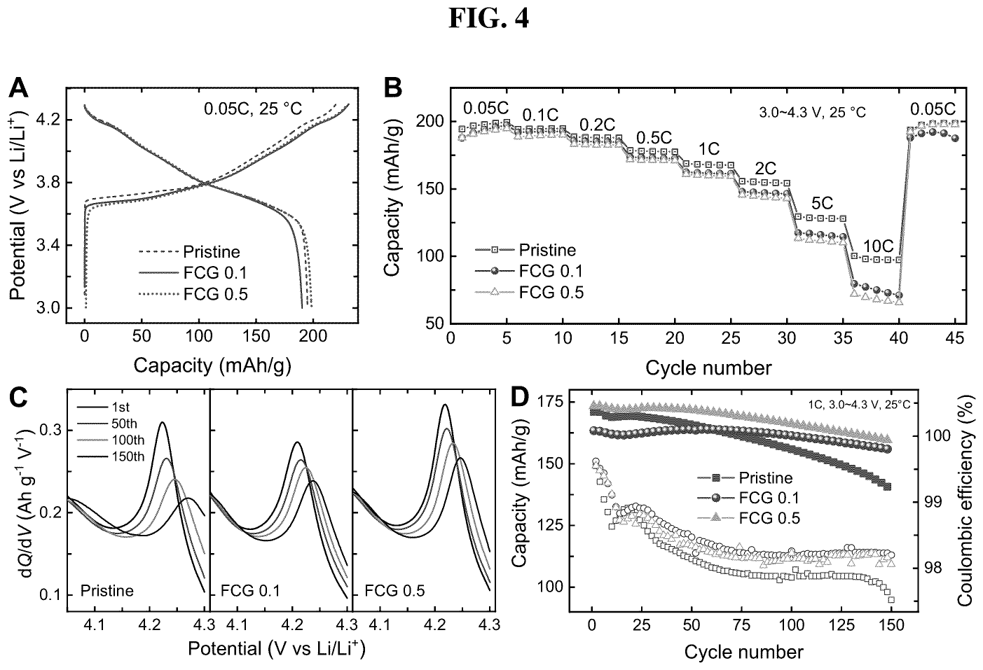

The cathode active material prepared in Examples 1 to 5 and the cathode active material prepared in Comparative Example 1 were applied to 2032-type coin cells, and measurement was performed with the cell using a galvanostatic cycler (M340A; LANHE Co.) from 3.0 to 4.3 V at 25° C. The results are shown in FIG. 4.

FIG. 4 and Table 3 show the electrochemical performances of the coin-type cells made from the active materials of Examples 1 to 5 and Comparative Example 1: A is the voltage profiles; B shows specific capacity at different C-rates, that is, rate capabilities; C represents differential capacity plots after different number of cycles; and D is the cycling stability test results at 1C rate. The initial discharge capacity and the initial coulombic efficiency at 0.05C, the discharge capacity retention rate after 150 cycles at 1C, and the capacity retention rate at 1° C. compared to 0.05C are sequentially shown in Table 3. Here, C-rate was determined based on the theoretical capacity of 275.5 mAhg⁻¹. In the differential capacity plots, the oxidation peaks of Examples 1 and 2 sustain the intensity and position during the 150 cycles; on the other hand, Comparative Example 1 shows more severe deterioration in the intensity and position. From the cycling test results, it can be confirmed that the cycling stability of the cells manufactured with the active materials according to Examples 1 to 5 were improved compared to Comparative Example 1. The active materials of Examples 1 to 5 commonly showed cycling stability improved by more than 10% compared to Comparative Example 1 (Table 3), and showed coulombic efficiency improved by up to 0.7% (FIG. 4, D). These observations evidence the improved electrochemical stability of the cathode active materials with tailor-made concentration gradients.

TABLE 3
Electrochemical performances of NCM811 cathode active
materials with different concentration gradients

| | Initial | Initial | Capacity | Capacity |
|---|---|---|---|---|
| | discharge | coulombic | retention | retention |
| | capacity | efficiency | after 150 | at 10 C compared |
| | (mAh g⁻¹) | (%) | cycles (%) | to 0.05 C (%) |
| Example 1 | 190.3 | 82.3 | 95.0 | 36.0 |
| Example 2 | 198.5 | 86.3 | 91.3 | 33.8 |
| Example 3 | 193.9 | 88.9 | 91.6 | 37.5 |
| Example 4 | 184.9 | 85.5 | 96.6 | 36.2 |
| Example 5 | 186.1 | 85.8 | 91.8 | 41.0 |
| Comparative | 195.1 | 88.7 | 81.5 | 48.8 |
| Example | | | | |

By the solution to the problems described above, the present invention may allow for mass production of high-energy and high-stability cathode materials for lithium secondary batteries by co-precipitation, which can freely design and control the average composition and the concentration gradient by using only nickel sulfate, cobalt sulfate, and manganese sulfate, and may achieve coating and doping effects without adding other raw materials.

In addition, the concentration gradient-tailor-made cathode active material prepared by the preparing method of the present invention has the highest concentration of nickel at the center and higher concentrations of cobalt and manganese toward the surface, and the average composition and the concentration gradient of metal ions can be freely designed and controlled to synthesize a tailor-made high-capacity cathode active material with improved stability.

In addition, the present invention may allow for synthesis of a cathode active material in which the average composition and the concentration gradient are precisely controlled according to the design, and the concentration gradient-tailor-made cathode active material synthesized through this method has improved surface stability, thus exhibiting excellent capacity, columbic efficiency, and cycling stability.

As such, those skilled in the art will understand that the technical configuration of the present invention described above can be implemented in other specific forms without changing the technical idea or essential features of the present invention.

Therefore, the embodiments described above should be understood in all respects as illustrative and not restrictive, and the scope of the present invention is indicated by the claims described later rather than the detailed descriptions above, and the meaning and scope of the claims, and all changes or modified forms derived from the equivalent concept should be construed as falling within the scope of the present invention.

### REFERENCE NUMERALS

S10. Aqueous metal ion solution preparation step
S20. Mixed metal ion solution formation step
S30. Control step
S40. Co-precipitation reaction step
S50. Active material preparation step

What is claimed is:

1. A preparing method for a cathode active material precursor for a lithium-ion batteries with a tailor-made concentration gradient, comprising:
an aqueous metal ion solution preparation step for preparing an aqueous metal ion solution A for center and an aqueous metal ion solution B for surface having different compositions, concentrations, and volumes;
a mixed metal ion solution formation step for gradually mixing the aqueous metal ion solution B for surface to the aqueous metal ion solution A for center;
a control step for setting a composition and a concentration gradient of the mixed metal ion solution and controlling the same in real time, before moving the mixed metal ion solution to a co-precipitation reactor; and
a co-precipitation reaction step for performing a co-precipitation reaction according to conditions set in the control step.

2. The preparing method for a cathode active material precursor for a lithium-ion batteries with a tailor-made concentration gradient according to claim 1, wherein in the aqueous metal ion solution preparation step, the aqueous metal ion solution A for center is an aqueous solution of nickel sulfate, and the aqueous metal ion solution B for surface is aqueous solutions of cobalt sulfate and manganese sulfate.

3. The preparing method for a cathode active material precursor for lithium-ion batteries with a tailor-made concentration gradient according to claim 1, wherein in the mixed metal ion solution formation step, a rate at which the aqueous metal ion solution B for surface is mixed into the mixing tank is represented by [Mathematical Formula 1] below, which is a function of time (t):
u₂(t)=u₂(0)×exp(t/τ) [Mathematical Formula 1]
wherein, the initial mixing rate is u₂(0) and the time constant is τ.

4. The preparing method for a cathode active material precursor for a lithium-ion batteries with a tailor-made concentration gradient according to claim 1, wherein in the control step above, concentration and composition changes of the mixed metal ion solution put into the co-precipitation reactor are represented and controlled by a differential equation of [Mathematical Formula 5] below:
$$\frac{{dn}_{1} ( t )}{dt} + {n}_{1} ( t ) \cdot \frac{{u}_{1} ( t )}{{V}_{1} ( t )} - {C}_{2} {u}_{2} ( t ) = 0 \qquad [ Mathematical Formula 5 ]$$
wherein, the number of moles of nickel in the mixed metal ion solution is n₁(t); the volume of the mixed metal ion solution is V₁(t); the rate at which the mixed metal ion solution is put into the co-precipitation reactor is u₁(t); the rate at which the aqueous metal ion solution B for surface is mixed into the mixing tank is u₂(t); and the molar concentration of nickel in the aqueous metal ion solution B for surface is C₂.

5. The preparing method for a cathode active material precursor for lithium-ion batteries with a tailor-made concentration gradient according to claim 1, wherein in the control step, the average composition and the concentration gradient are freely controlled with initial mixing rate u₂(0) and time constant τ of the flow rate of the aqueous metal ion solution B for surface into the mixing tank as key parameters.

6. The preparing method for a cathode active material precursor for a lithium-ion batteries with a tailor-made concentration gradient according to claim 1, wherein in the co-precipitation reaction step, an ammonia solution and a sodium hydroxide solution are added to the co-precipitation reactor together with the mixed metal ion solution to perform a co-precipitation reaction.

7. The preparing method for a cathode active material precursor for a lithium-ion batteries with a tailor-made concentration gradient according to claim 6, wherein the ammonia solution and the sodium hydroxide solution are added such that the ammonia concentration and the pH in the reactor are maintained at pre-designed constant values in ranges of 0.5 to 1.2 M and 10.0 to 11.5, respectively.

8. The preparing method for a cathode active material precursor for a lithium-ion batteries with a tailor-made concentration gradient according to claim 7, wherein the mixed metal ion solution is added to the co-precipitation reactor under condition that a sum of all metal ion concentrations is maintained constantly.

9. A co-precipitation reactor with a tailor-made concentration gradient, comprising:
a first storage tank (mixing tank) storing an aqueous metal ion solution A for center;
a second storage tank storing an aqueous metal ion solution B for surface;
a co-precipitation reactor that performs co-precipitation reaction by receiving from the mixing tank a mixed metal ion solution prepared by mixing the aqueous metal ion solution B for surface into the mixing tank, together with an ammonia solution and a sodium hydroxide solution; and
a control system setting and controlling a composition and a concentration gradient of the mixed metal ion solution moving to the co-precipitation reactor.

10. The co-precipitation reactor for a tailor-made concentration gradient according to claim 9, wherein the control system comprises a flow rate control unit controlling a flow rate at which the aqueous metal ion solution B for surface is mixed into the mixing tank, and wherein the flow rate is expressed as an optimized solution of [Mathematical Formula 1] and [Mathematical Formula 5] below, which is correlated with flow rates (u₁ and u₂) and time (t):
u₂(t)=u₂(0)×exp(t/τ) [Mathematical Formula 1]
wherein, the initial mixing rate is u₂(0) and the time constant is τ,
$$\frac{{dn}_{1} ( t )}{dt} + {n}_{1} ( t ) \cdot \frac{{u}_{1} ( t )}{{V}_{1} ( t )} - {C}_{2} {u}_{2} ( t ) = 0 \qquad [ Mathematical Formula 5 ]$$
wherein, the number of moles of nickel in the mixed metal ion solution is n₁(t); the volume of the mixed metal ion solution is V₁(t); the rate at which the mixed metal ion solution is put into the co-precipitation reactor is u₁(t); the rate at which the aqueous metal ion solution B for surface is mixed into the mixing tank is u₂(t); and the molar concentration of nickel in the aqueous metal ion solution B for surface is C₂.

11. The co-precipitation reactor for a tailor-made concentration gradient according to claim 9, wherein the control system comprises a concentration control unit controlling a molar concentration (M) of a metal ion in the mixed metal ion solution, and in the concentration control unit, the molar concentration (M) of nickel in the mixed metal ion solution over time is expressed as a solution of [Mathematical Formula 2], [Mathematical Formula 3], and [Mathematical Formula 5] below:
V₁(t)=V₁(0)+∫₀^{T}[u₂(t)−u₁(t)]dt [Mathematical Formula 2]
wherein, the volume of the mixed metal ion solution is V₁(t); the rate at which the mixed metal ion solution is put into the co-precipitation reactor is u₁(t); and the rate at which the aqueous metal ion solution B for surface is mixed into the mixing tank is u₂(t),
$${C}_{1} ( t ) = \frac{{n}_{1} ( t )}{{V}_{1} ( t )} \qquad [ Mathematical Formula 3 ]$$
wherein, the molar concentration of nickel in the mixed metal ion solution is C₁(t); the number of moles of nickel in the mixed metal ion solution is n₁(t); and the volume of the mixed metal ion solution is V₁(t),
$$\frac{{dn}_{1} ( t )}{dt} + {n}_{1} ( t ) \cdot \frac{{u}_{1} ( t )}{{V}_{1} ( t )} - {C}_{2} {u}_{2} ( t ) = 0 \qquad [ Mathematical Formula 5 ]$$
wherein, the number of moles of nickel in the mixed metal ion solution is n₁(t); the volume of the mixed metal ion solution is V₁(t); the rate at which the mixed metal ion solution is put into the co-precipitation reactor is u₁(t); the rate at which the aqueous metal ion solution B for surface is mixed into the mixing tank is u₂(t); and the molar concentration of nickel in the aqueous metal ion solution B for surface is C₂.

12. The co-precipitation reactor with a tailor-made concentration gradient according to claim 9, wherein the control system comprises a mixed solution control unit changing concentration and composition of the mixed metal ion solution put into the co-precipitation reactor, and the mixed solution control unit implements u₂(t), which is a mixing rate of an aqueous metal ion solution for surface expressed as a numerical solution of the differential equation of [Mathematical Formula 5] below, as a function of time (t), with a computer-hardware interlocking system:
$$\frac{{dn}_{1} ( t )}{dt} + {n}_{1} ( t ) \cdot \frac{{u}_{1} ( t )}{{V}_{1} ( t )} - {C}_{2} {u}_{2} ( t ) = 0 \qquad [ Mathematical Formula 5 ]$$
wherein, the number of moles of nickel in the mixed metal ion solution is n₁(t); the volume of the mixed metal ion solution is V₁(t); the rate at which the mixed metal ion solution is put into the co-precipitation reactor is u₁(t); the rate at which the aqueous metal ion solution B for surface is mixed into the mixing tank is u₂(t); and the molar concentration of nickel in the aqueous metal ion solution B for surface is C₂.

13. The co-precipitation reactor with a tailor-made concentration gradient according to claim 9, wherein the control system variously controls the concentration gradient using initial mixing rate u₂(0) and time constant τ for the flow rate of the metal ion solution B for surface into the mixing tank, and initial volume V₁(0) of the metal ion solution A for center in the mixing tank as optimized parameters.

14. A preparing method for a cathode active material for lithium-ion batteries with a tailor-made concentration gradient, comprising:
an aqueous metal ion solution preparation step for preparing an aqueous metal ion solution A for center and an aqueous metal ion solution B for surface having different compositions, concentrations, and volumes;
a mixed metal ion solution formation step for gradually mixing the aqueous metal ion solution B for surface to the aqueous metal ion solution A for center;
a control step for setting a composition and a concentration gradient of the mixed metal ion solution and controlling the same in real time, before moving the mixed metal ion solution to a co-precipitation reactor;
a co-precipitation reaction step for performing a co-precipitation reaction according to conditions set in the control step; and
an active material preparation step for mixing a cathode active material precursor synthesized above and lithium hydroxide, and then heating and sintering the same to prepare a final active material.

15. The preparing method for a cathode active material for lithium-ion batteries with a tailor-made concentration gradient according to claim 14, wherein in the active material preparation step, the heating is performed at a temperature increase rate of 5° C./min or less.

16. The preparing method for a cathode active material for lithium-ion batteries with a tailor-made concentration gradient according to claim 14, wherein the sintering is performed at 600 to 800° C. for 10 to 15 hours.
